(19) United States
(12) Patent Application Publication
(10) Pub. No.: US 2023/0124093 A1
(43) Pub. Date: Apr. 20, 2023

(54) BATH FIXTURE ATTACHMENT DEVICE

(71) Applicant: Starisha Simpson, Bay Shore, NY (US)

(72) Inventor: Starisha Simpson, Bay Shore, NY (US)

(21) Appl. No.: 17/876,631

(22) Filed: Jul. 29, 2022

Related U.S. Application Data
(60) Provisional application No. 63/257,078, filed on Oct. 18, 2021.

(51) Int. Cl. A47K 3/28; B05B 15/62; B05B 1/18; H04R 1/02

(52) U.S. Cl. CPC A47K 3/281; B05B 15/62; B05B 1/185; H04R 1/028

(57) ABSTRACT

Described herein are embodiments of an attachment for a bath fixture. The attachment comprises a coupling element which connects a body portion and the faucet. The body portion comprises a structure which is configured to output the water from the faucet with the back side of the body portion configured to attach to a wall using a plurality of fasteners disposed between the back side of the structure and the wall.

### CROSS REFERENCE TO RELATED APPLICATIONS

This application claims priority to U.S. Provisional Patent Application No. 63/257,078 filed on Oct. 18, 2021, which is herein incorporated by reference in its entirety.

### BACKGROUND

If there is dirt, a child will find it. Cleaning that dirt off, however, is never as easy as it is for them to find it. Acclimating children to using the bathroom for showering can present a problem for parents to overcome. Children can become resistant to showers and may protest good hygiene all together. Also, the bathroom can be a scary place to small children—with a tall, unreachable shower nozzle; a difficult to reach faucet; and other sterile and boring surfaces that do nothing to create engagement with the child.

Parents with small children can appreciate that showering is not always a stress-free endeavor, and these parents often employ any means necessary to make the space more welcoming for the child. Some parents try to achieve this by adding toys or other distractions. However, these implements merely distract the child while the parent is then tasked with all of the cleaning and scrubbing. The child is rarely encouraged to shower themselves, which may only exacerbate the child's hesitancy in using the shower and limit the child's hygiene independence.

What is needed is a device to increase a child's engagement and interest during shower time to lower resistance in small children and create an independent, fun experience which also serves to increase the child's motor skills.

### SUMMARY

A child's engagement with showering is improved according to certain illustrative aspects of the invention as described herein in connection with the follow description and drawings.

The invention, in one aspect, features an attachment for a bath fixture. The attachment comprises a coupling element which connects a body portion and the faucet. The body portion comprises a structure which is configured to direct water from the faucet with the back side of the body portion configured to attach to a wall using a plurality of fasteners disposed between the back side of the structure and the wall.

In some embodiments, the structure is the face of an animal. In some embodiments, the structure is a face of an elephant where the elephant's trunk acts as an extended shower head. In some embodiments, the animal face is constructed of soft, bendable plastic which allows flexing of the attachment in a more preferable position, granting more control of the water flow.

In some embodiments, the attachment contains a receptacle attached to the structure. The receptacle can contain a fluid dispenser, which allow for shampoo, conditioner, soap, or some other desired liquid to be placed into the receptacle. In some embodiments, the receptacle has a soft, malleable side which is utilized as a push pump, allowing a force exerted upon the malleable side to dispense the contents of the receptacle. In some embodiments, the receptacle comprises a pump dispenser for dispensing the contents of the receptacle. In some embodiments, the pump dispenser are similar to those found on industry standard conditioner and shampoo bottles. In other embodiments, the receptacle is a push button dispenser similar to those found in industrial push button liquid soap dispensers.

In some embodiments the attachment includes a coupling element which is connected to the bathtub faucet to allow operation of a standard shower head for adult use while also enabling a quick conversion to the attachment. In some embodiments, the attachment comprises a coupling element that attaches to the shower head, allowing use of the normal bathtub faucet. In some embodiments the coupling element comprises an attachment method configured to accept a water delivery system.

In some embodiments the fasteners used to attach the structure to the wall are suction cups. In some embodiments, the fasteners are a hook and loop system, commonly known as Velcro™. In some embodiments, the fasteners comprise a waterproof adhesive.

In some embodiments, the attachment has an acoustic delivery system, allowing music or noises to be played during the shower.

In some embodiments, the attachment also includes a handle connected to the body portion.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

The systems, devices and methods may be better understood by referring to the following description in conjunction with the accompanying drawings, in which like numerals indicate like structural elements and features in various figures. The components in the figures are not necessarily to scale, and simply illustrate the principles of the systems, devices and methods. The accompanying drawings illustrate only possible embodiments of the systems, devices and methods and are therefore not to be considered limiting in scope.

FIG. 1 is a frontal facing isometric view illustrating the front of an embodiment of the water outlet attachment.

FIG. 2 is an isometric view illustrating the back of an embodiment of the water outlet attachment.

FIG. 3 is a side view illustrating an embodiment of the water outlet attachment.

FIG. 4 is front view illustrating an embodiment of the water outlet attachment.

### DETAILED DESCRIPTION

Aspects of the system and methods are described below with reference to illustrative embodiments. The references to illustrative embodiments below are not made to limit the scope of the claimed subject matter. Instead, illustrative embodiments are used to aid in the description of various aspects of the systems and methods. The description, made by way of example and reference to illustrative reference is not meant to be limiting as regards any aspect of the claimed subject matter.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

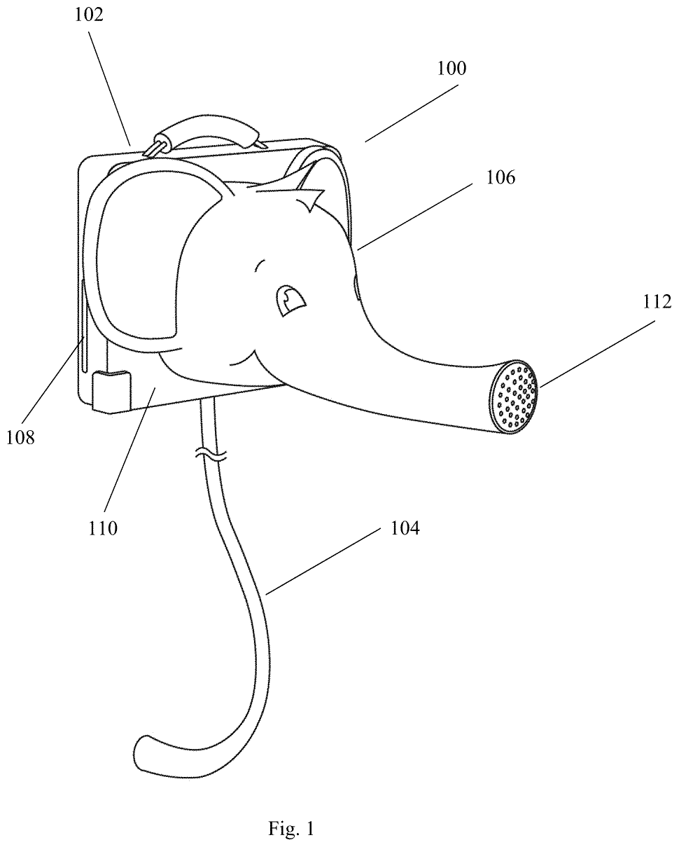

FIG. 1 is a frontal facing isometric view illustrating the front of an embodiment of the water outlet attachment. Referring now to FIG. 1, an embodiment illustrating a water outlet attachment 100 is shown. The water outlet attachment 100 connects to a water source by a coupling element 104. The coupling element 104 feeds water from the water source (e.g., a bath faucet or spigot) up to the body portion 102, exiting through the output 112. It should be appreciated that the use of water is exemplary; and the coupling element 104 can deliver any of a number of different liquids from a given source. The body portion 102 has a front side of the body portion 110 and a back side of the body portion 204. On the front side of the body portion 110 is a structure 106 that can deliver the water from the water source in an effective manner. In the shown embodiment, the structure 106 is a head of an elephant with the water being delivered through the trunk. In certain embodiments, there is a receptacle 108 that can be used to contain a liquid used during bathing, such as shampoo, soap, or conditioner.

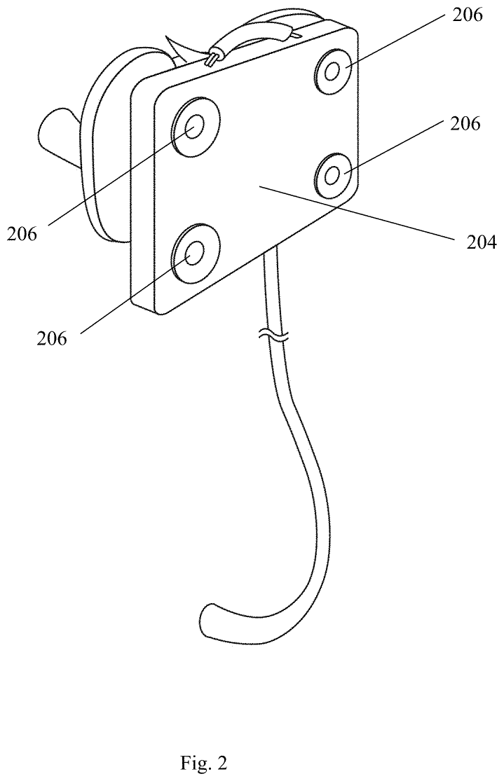

FIG. 2 is an isometric view illustrating the back of an embodiment of the water outlet attachment. Attached to the back side of the body portion 204 are a plurality of fasteners 206 that can be used to affix the water outlet attachment 100 to a wall at a suitable height and location. In the shown embodiment, the plurality of fasteners 206 are suction cups, although the fasteners can be other types of permanent, semi-permanent, or removable fasteners.

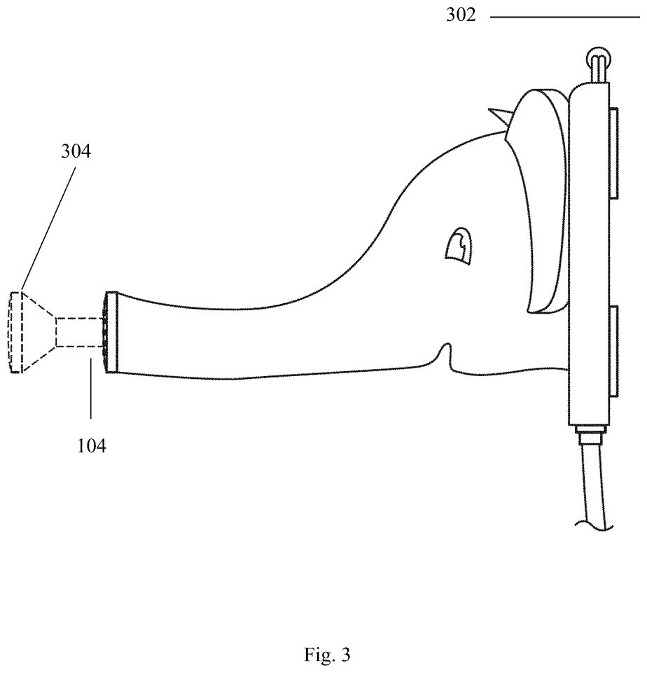

FIG. 3 is a side view illustrating an embodiment of the water outlet attachment. The plurality of fasteners 206 are affixed to a wall 302 and the structure 106 points toward the bathing area. The coupling element 104 feeds the water directly to a nozzle 304, as shown by the projected outline in the embodiment shown in FIG. 3.

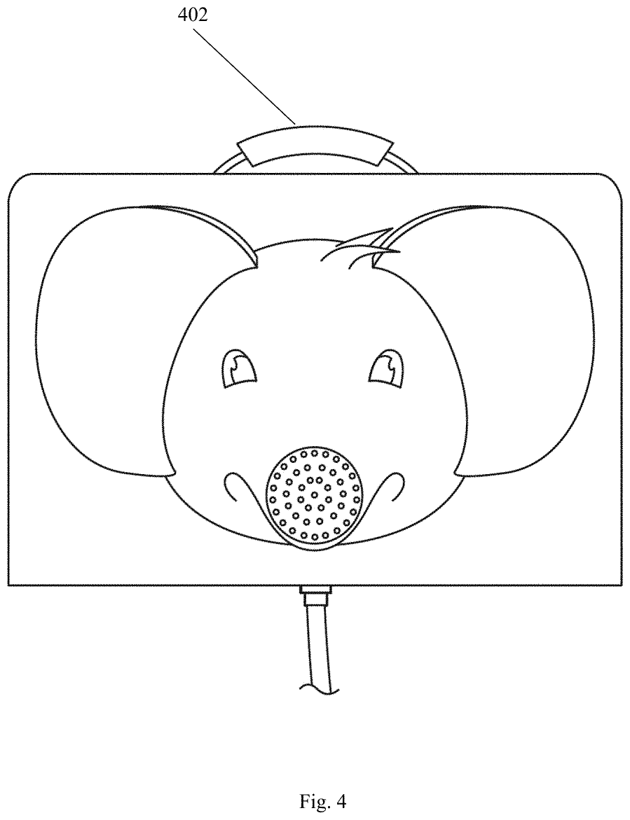

FIG. 4 is front view illustrating an embodiment of the water outlet attachment. In certain embodiments, a handle 402 is attached to the body portion 102. The handle provides an easy way to move the water outlet attachment (e.g., to a different position on the wall) and also enables simple portability of the attachment.

What is claimed is:

1. A water outlet attachment, the attachment comprising:
a body portion;
a coupling element connected to the body portion and configured to be attached to a water source;
the body portion further comprising:
a structure configured to direct water from the water source to an output;
a front side; and
a back side, wherein the back side includes a plurality of fasteners attached to the back side for securing the body portion to the wall.

2. The attachment of claim 1 wherein the structure is the face of an animal.

3. The attachment of claim 2 wherein the animal face is constructed of soft, bendable plastic, allowing malleability and directionality of water flow.

4. The attachment of claim 2 wherein the animal face is that of an elephant.

5. The attachment of claim 4 wherein the trunk of the elephant is at least 7 inches long.

6. The attachment of claim 1 further comprising:
a receptacle attached to the structure, the receptacle configured to dispense a fluid contained therein; and
a liquid input for depositing the fluid into the receptacle.

7. The attachment of claim 6 wherein the receptacle further comprises a soft, malleable side which acts as a pump to dispense the liquid contained within the receptacle.

8. The attachment of claim 6 wherein the receptacle further comprises a pump dispenser to dispense the liquid contained within the receptacle.

9. The attachment of claim 1 wherein the coupling element comprises a connector to a bathtub faucet.

10. The attachment of claim 1 wherein the coupling element comprises a connector attached to a shower head.

11. The attachment of claim 1 wherein the coupling element comprises an attachment method configured to accept a water delivery system.

12. The attachment of claim 1 wherein the fasteners are suction cups.

13. The attachment of claim 1 wherein the fasteners are a hook and loop system.

14. The attachment of claim 1 wherein the fasteners are a waterproof adhesive.

15. The attachment of claim 1 further comprising an acoustic delivery system.

16. The attachment of claim 1 further comprising a handle connected to the body portion.
